(19) United States
(12) Patent Application Publication
(10) Pub. No.: US 2020/0132901 A1
(43) Pub. Date: Apr. 30, 2020

(54) DISPLAY MODULE AND POLARIZER THEREOF

(71) Applicant: HUIZHOU CHINA STAR OPTOELECTRONICS TECHNOLOGY CO., LTD., Huizhou Guangdong (CN)

(72) Inventor: Bo HAI, Huizhou Guangdong (CN)

(21) Appl. No.: 15/752,490

(22) PCT Filed: Dec. 15, 2017
(86) PCT No.: PCT/CN2018/073508

§ 371 Date: Feb. 13, 2018

(30) Foreign Application Priority Data
Dec. 15, 2017 (CN) 201711345598.8

(51) Int. Cl. G02B 5/30; G02B 1/14; G02F 1/1335

(52) U.S. Cl. CPC G02B 5/305; G02F 1/1368; G02F 1/133528; G02B 1/14

(57) ABSTRACT

The present invention provides a display module and a polarizer thereof. The polarizer includes a first adhesive layer, a polarizing layer, a second adhesive layer and a protective layer, the polarizing layer disposed between the first adhesive layer and the second adhesive layer, the second adhesive layer disposed between the polarizing layer and the protective layer, wherein a material of the polarizing layer is high temperature resistance and high humidity resistance polyvinyl alcohol to make a temperature resistance of the polarizer is not less than 60° C. and a humidity resistance is not less than 80%. The present invention provides another polarizer. The polarizer further includes a third adhesive layer and a compensation film layer. The third adhesive layer and the compensation film layer are disposed between the first adhesive layer and the polarizing layer. The compensation film layer is located between the first adhesive layer and the third adhesive layer.

### RELATED APPLICATIONS

The present application is a National Phase of International Application Number PCT/CN2018/073508, filed Jan. 19, 2018, and claims the priority of China Application 201711345598.8, filed Dec. 15, 2017.

### FIELD OF THE DISCLOSURE

The disclosure relates to a liquid crystal display technology, and more particularly to a display module and a polarizer thereof.

### BACKGROUND

With the development of liquid crystal display technology, liquid crystal television has become popular, and large-size LCD TV has become user's favorite, because of large display area and visual effects shock, the LCD TV of 55-inch and above has become the market mainstream choice for high-end models currently. However, the larger the size of the liquid crystal panel, the warpage is more likely to occur. In addition, in order to reduce the weight and the cost, the thickness of the glass substrate used in the large-size liquid crystal panel has been changed from 0.7 mm to 0.5 mm. The thinner the glass substrate, the greater the impact of external forces, more prone to occur warpage. Therefore, the liquid crystal panel in the high temperature and high humidity test or in the thermal shock test, the large-size thin-type liquid crystal panel is prone to occur warpage, the warpage will lead to light leakage, thus affecting the taste. For the panel warpage caused by high humidity, the structure of the polarizer with high humidity resistance can be used to improve. However, the warpage caused by the thermal shock is not necessarily improved by using the polarizer with high humidity resistance. Therefore, it is necessary to improve panel warpage caused by high temperature.

### SUMMARY

In order to solve the insufficient of the conventional technology, the present invention provides a display module and a polarizer thereof, to reduce the stress of the polarizer under high temperature environment, weaken the bending of the display module, to avoid the light leakage around the display module and improve the display module's display quality.

The specific technical solution proposed by the present invention is to provide a polarizer, including: a first adhesive layer, a polarizing layer, a second adhesive layer and a protective layer, the polarizing layer disposed between the first adhesive layer and the second adhesive layer, the second adhesive layer disposed between the polarizing layer and the protective layer, wherein a material of the polarizing layer is high temperature resistance and high humidity resistance polyvinyl alcohol, PVA to make a temperature resistance of the polarizer is not less than 60° C. and a humidity resistance is not less than 80%.

Further, the humidity resistance is not less than 90%.

Further, a thickness of the polarizing layer is 10-20 μm, and/or a thickness of the protective layer is 10-20 μm.

Further, a material of the first adhesive layer is a pressure sensitive adhesive, the pressure sensitive adhesive is a soft pressure sensitive adhesive, and/or a material of the protective layer is selected from a material with thermal expansion coefficient lower than the thermal expansion coefficient of TAC, and/or a material of the second adhesive layer is UV adhesive.

The present application further provides another polarizer, including: a first adhesive layer, a polarizing layer, a second adhesive layer, a third adhesive layer, a compensation film layer and a protective layer, the polarizing layer disposed between the first adhesive layer and the second adhesive layer, the second adhesive layer disposed between the polarizing layer and the protective layer, the third adhesive layer and the compensation film layer disposed between the first adhesive layer and the polarizing layer, the compensation film layer disposed between the first adhesive layer and the third adhesive layer, wherein a material of the polarizing layer is high temperature resistance polyvinyl alcohol to make a temperature resistance of the polarizer is not less than 60° C.

Further, the temperature resistance of the polarizer is not less than 80° C.

Further, materials of the second adhesive layer and the third adhesive layer are UV adhesive.

Further, a thickness of the polarizing layer is 10-20 μm, and/or a thickness of the compensation film layer is 20-40 μm, and/or a thickness of the protective layer is 10-20 μm.

Further, a material of the first adhesive layer is a pressure sensitive adhesive, the pressure sensitive adhesive is a soft pressure sensitive adhesive, and/or a material of the protective layer is selected from a material with thermal expansion coefficient lower than the thermal expansion coefficient of TAC.

The present application further provides a display module, the display module including a first polarizer, a second polarizer, and a display layer disposed between the first polarizer and the second polarizer, each of the first polarizer and the second polarizer are all polarizers as described above.

The material of the polarizing layer of the polarizer provided by the present invention is a high temperature resistance and high humidity resistance PVA, so that the temperature resistance of the polarizer is not less than 60° C. and the humidity resistance is not less than 80%, so that it is possible to prevent the polarizing layer from molecular chain contraction caused by absorption of temperature and humidity and leading to the generation of stress of the polarizer. The material of the polarizing layer of the polarizer provided by the present invention is a high temperature resistance and high humidity resistance PVA, so that the temperature resistance of the polarizer is not less than 60° C., so that it is possible to prevent the polarizing layer from molecular chain contraction caused by absorption of temperature and humidity and leading to the generation of stress of the polarizer. Both structures can reduce the stress of the polarizer, and to weaken the bending degree of the display module, thereby avoiding the phenomenon of light leakage around the display module and improving the display quality of the display module.

### BRIEF DESCRIPTION OF THE DRAWINGS

FIG. 1 is a schematic structural diagram of the polarizer in the first embodiment;

FIG. 2 is a schematic structural diagram of another polarizer in the first embodiment;

FIG. 3 is a schematic structural diagram of another polarizer in the first embodiment;

FIG. 4 is a schematic structural diagram of another polarizer in the first embodiment;

FIG. 5 is a schematic structural diagram of another polarizer in the first embodiment;

FIG. 6 is a schematic structural diagram of the display module in the first embodiment;

FIG. 7 is a schematic structural diagram of the polarizer in the second embodiment;

FIG. 8 is a schematic structural diagram of another polarizer in the second embodiment;

FIG. 9 is a schematic structural diagram of another polarizer in the second embodiment;

FIG. 10 is a schematic structural diagram of another polarizer in the second embodiment; and

FIG. 11 is a schematic structural diagram of another display module in the first embodiment.

### DETAILED DESCRIPTION OF PREFERRED EMBODIMENTS

Hereinafter, embodiments of the present invention will be described in detail with reference to the accompanying drawings. However, the invention may be embodied in many different forms and should not be construed as limited to the specific embodiments set forth herein. Rather, these embodiments are provided to explain the principles of the invention and its practical application to thereby enable those of ordinary skill in the art to understand various embodiments of the invention and various modifications as are suited to the particular use contemplated. In the drawings, the same reference numerals will always be used to refer to the same elements.

### First Embodiment

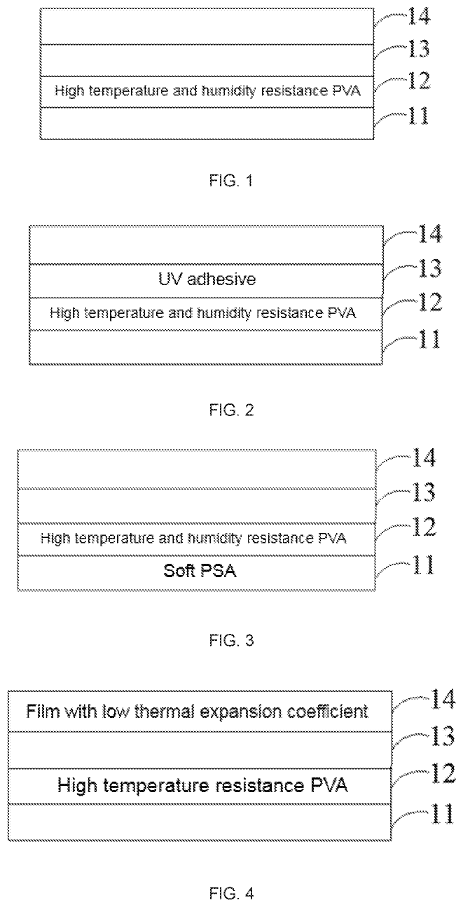

Referring to FIG. 1, a polarizer provided in this embodiment includes a first adhesive layer 11, a polarizing layer 12, a second adhesive layer 13 and a protective layer 14. The polarizing layer 12 is disposed between the first adhesive layer 11 and the second adhesive layer 13. The second adhesive layer 13 is disposed between the polarizing layer 12 and the protective layer 14. The polarizing layer 12 is made of high temperature resistance and high humidity resistance polyvinyl alcohol (PVA), so that the temperature resistance of the polarizer is not less than 60° C. and the humidity resistance is not less than 80%.

The material of the polarizing layer 12 in this embodiment is the high temperature resistance and high humidity resistance PVA, so that the temperature resistance of the polarizer is not less than 60° C. and the humidity resistance is not less than 80%, so that it is possible to prevent the polarizing layer 12 from molecular chain contraction caused by absorption of temperature and humidity and leading to the generation of stress of the polarizer, and to weaken the bending degree of the display module, thereby avoiding the phenomenon of light leakage around the display module and improving the display quality of the display module.

Preferably, the material of the polarizing layer 12 is the high temperature resistance and high humidity resistance PVA, so that the temperature resistance of the polarizer is not less than 60° C. and the humidity resistance is not less than 90%. Wherein, the temperature resistance of the polarizer means that the polarizer does not generate chemical changes or physical damage due to thermal expansion at the temperature. Similarly, the humidity resistance of the polarizer means that the polarizer does not generate chemical reaction or physical damage at the humidity. Since the polarizer has relatively high temperature resistance, the stress caused by thermal expansion under the high temperature environment is relatively small, so as to reduce the degree of bending of the display module, thereby avoiding the phenomenon of light leakage around the display module.

Taking the temperature resistance of the polarizer is 60° C. and the humidity resistance is 90% as an example, in the actual testing process, the humidity resistance is obtained by attaching a polarizer sample having a size of 40×40 mm to a clean glass by a roller. Placed in a 60° C.*5 kgf/cm² environment for 15 minutes, and then the polarizer sample was placed in a furnace at a temperature of 60° C. and a humidity of 90% for 500 hours, finally taken out the polarizer sample, and judging whether the change of the transmittance of the polarizer sample is not more than 5%. If it is not more than 5%, the temperature resistance of the polarizer is 60° C. and the humidity resistance of the polarizer is 90%.

The first adhesive layer 11 is used to adhere the polarizer to the glass substrate. The polarizing layer 12 has polarizing and analyzing functions. The second adhesive layer 13 is used to adhere the polarizing layer 12 and the protective layer 14, The protective layer 14 has the function of blocking water vapor, and is used for supporting the entire polarizer at the same time.

In this embodiment, the material of the first adhesive layer 11 is PSA (Pressure Sensitive Adhesive), the material of the protective layer 14 is Triacetyl Cellulose (TAC), the material of the second adhesive layer 13 water-based adhesive or UV adhesive.

Referring to FIG. 2, in order to reduce the stress of the entire polarizer, preferably, the material of the second adhesive layer 13 in this embodiment is UV adhesive. Since the UV adhesive is a material containing no hydrophilic organic solvent, it can reduce the stress caused by the shrinkage of the molecular chain due to the absorption of water in the polarizing layer 12, thereby reducing the bending of the display module.

In this embodiment, it is also possible to reduce the stress of the entire polarizer by reducing the thickness of the polarizing layer 12, wherein, the thickness of the polarizing layer 12 is 10 to 20 μm. By using a thin-type PVA of the polarizing layer 12, the thickness of the entire polarizer can be effectively reduced, thereby reducing the stress generated by the thermal expansion of the polarizing layer 12 and reducing the degree of bending of the display module.

Similarly, in this embodiment, the stress of the entire polarizer can also be reduced by reducing the thickness of the protective layer 14, wherein the thickness of the protective layer 14 is 20-40 μm. By using a thin-type TAC of the protective layer 14, the thickness of the entire polarizer can be effectively reduced, so as to reduce the stress of the entire polarizer, and reduce the degree of bending of the display module.

Referring to FIG. 3, in this embodiment, the stress of the entire polarizer can also be reduced by changing the viscosity of the first adhesive layer 11. Wherein, the first adhesive layer 11 is a soft PSA, that is the PSA is the soft PSA, the soft PSA here refers to a PSA having a glass transition temperature of −20° C. to −70° C., and by selecting the first adhesive layer 11 as the soft PSA can reduce the stress of the entire polarizer, and reduce the degree of bending of the display module.

Referring to FIG. 4, in addition, in this embodiment, the stress of the entire polarizer can also be reduced by selecting the material of the protective layer 14 as a film with low thermal expansion coefficient. Here, the film with low thermal expansion coefficient refers to a material having a thermal expansion coefficient lower than the thermal expansion coefficient of TAC. Since the material of the protective layer 14 is made of a material with a relatively low thermal expansion coefficient, the stress generated by the protective layer 14 during the heating process is relatively small, so that the stress of the entire polarizer can be reduced.

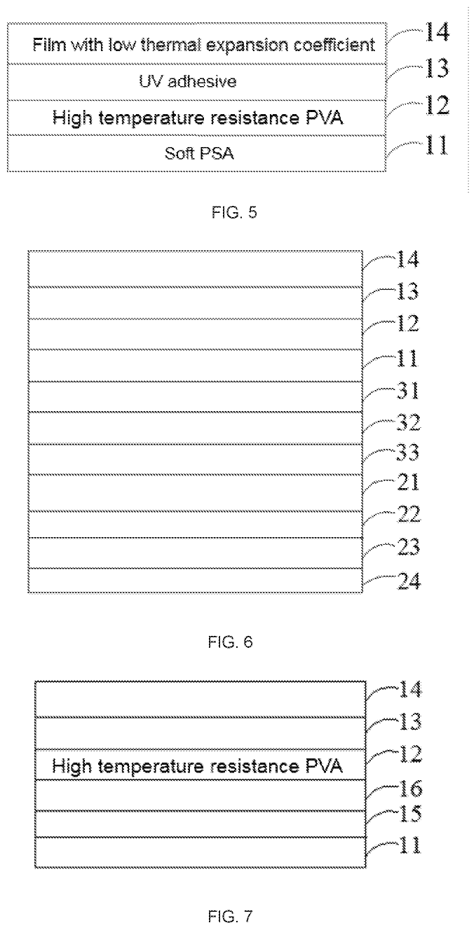

Of course, in order to better reduce the stress of the entire polarizer, the above several solutions can be arbitrarily combined. For example, the material of the second adhesive layer 13 is UV adhesive, the temperature resistance of the polarizing layer 12 is higher than 60° C., and the humidity resistance of the polarizer is greater than 90%; alternatively, the material of the second adhesive layer 13 is UV adhesive, the temperature resistance of the polarizing layer 12 is higher than 60° C., and the humidity resistance of the polarizer is greater than 90%, the thickness of the polarizing layer 12 is 10-20 μm, the thickness of the protective layer 14 is 20-40 μm; alternatively, the material of the second adhesive layer 13 is UV adhesive, the temperature resistance of the polarizing layer 12 is higher than 60° C., and the humidity resistance of the polarizer is greater than 90%, the thickness of the polarizing layer 12 is 10-20 μm, the thickness of the protective layer 14 is 20-40 μm, the first adhesive layer 11 is the soft PSA; alternatively, the material of the second adhesive layer 13 is UV adhesive, the temperature resistance of the polarizing layer 12 is higher than 60° C., and the humidity resistance of the polarizer is greater than 90%, the thickness of the polarizing layer 12 is 10-20 μm, the thickness of the protective layer 14 is 20-40 μm, the first adhesive layer 11 is the soft PSA, the material of the protective layer 14 is the material with a relatively low thermal expansion coefficient, as shown in FIG. 5.

The thickness of the polarizer in this embodiment is relatively thin and can effectively reduce the stress of the polarizer, and reduce the degree of bending of the display module, so as to avoid the light leakage around the display module, and improve the display quality of the display module.

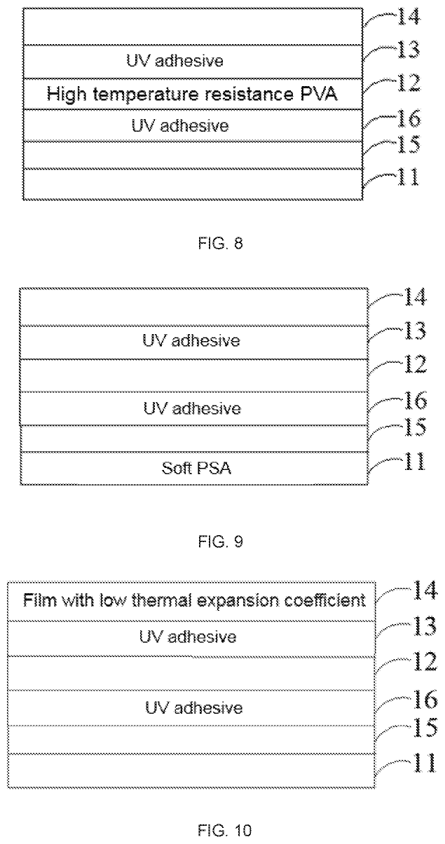

Referring to FIG. 6, the present embodiment further provides a display module, including a first polarizer, a second polarizer and a display layer. The display layer is located between the first polarizer and the second polarizer. The optical axes of the first polarizer and the second polarizer are perpendicular to each other, and both the first polarizer and the second polarizer are the above polarizers, wherein the structures of the first polarizer and the second polarizer may be the same or different.

For example, the first polarizer includes, in order from the bottom to the top, the first adhesive layer 11, the polarizing layer 12, the second adhesive layer 13 and the protective layer 14 sequentially disposed away from the display layer, and the second polarizer includes, in order from the bottom to the top, the protective layer 24, the second adhesive layer 23, the polarizing layer 22 and the first adhesive layer 21 In this case, the structures of the first polarizer and the second polarizer are the same, and the first polarizer and the second polarizer may be any one of the above polarizers. Since the second polarizer is in contact with a backlight module, the heat generated in the backlight module is transmitted to the second polarizer. Preferably, in the present embodiment, the protective layer 24 of the second polarizer is thin type TAC or its material is selected from materials with a lower thermal expansion coefficient.

The display layer in this embodiment includes a OF substrate 31, a liquid crystal layer 32 and a TFT substrate 33. The liquid crystal layer 32 is located between the CF substrate 31 and the TFT substrate 33. The CF substrate 31 is located between the first polarizer and the liquid crystal layer 32. Since the first polarizer and the second polarizer sandwich the display layer therebetween, therefore the degree of bending of the display module can be weakened by reducing the stress of the first polarizer and the second polarizer, so that the phenomenon of light leakage around the display module can be avoided.

### Second Embodiment

Referring to FIG. 7, the polarizer provided in this embodiment includes a first adhesive layer 11, a polarizing layer 12, a second adhesive layer 13, a protective layer 14, a compensation film layer 15 and a third adhesive layer 16. The polarizing layer 12 is disposed between the first adhesive layer 11 and the second adhesive layer 13, the second adhesive layer 13 is disposed between the polarizing layer 12 and the protective layer 14, the compensation film layer 15 and the third adhesive layer 16 are disposed between the first adhesive layer 11 and the polarizing layer 12, the compensation film layer 15 is disposed between the first adhesive layer 11 and the third adhesive layer 16. In this embodiment, the polarizing layer 12 is made of high temperature resistance PVA, so that the temperature resistance of the polarizer is not less than 80° C., thereby reducing the stress of the entire polarizer.

Preferably, the polarizing layer 12 in this embodiment is a high temperature resistance PVA, so the temperature resistance of the polarizer is not less than 80° C., thereby reducing the stress of the entire polarizer. Wherein, the temperature resistance of the polarizer means that the polarizer does not cause chemical changes or physical damage due to thermal expansion at that temperature. Since the polarizer has relatively high temperature resistance, the stress caused by thermal expansion under high temperature environment is relatively small, which can reduce the degree of bending of the display module and avoid the light leakage around the display module.

Taking the temperature resistance of the polarizer is 80° C. as an example, in the actual testing process, the temperature resistance is obtained by attaching a polarizer sample having a size of 40×40 mm to a clean glass by a roller. Placed in a 60° C.*5 kgf/cm² environment for 15 minutes, and then the polarizer sample was placed in a furnace at a temperature of 80° C. for 500 hours, finally taken out the polarizer sample, and judging whether the change of the transmittance of the polarizer sample is not more than 5%. If it is not more than 5%, the temperature resistance of the polarizer is 80° C.

Referring to FIG. 8, the material of the second adhesive layer 13 and the third adhesive layer 16 in this embodiment are UV adhesive. The first adhesive layer 11 is used to adhere the polarizer to the glass substrate. The polarizing layer 12 has polarizing and analyzing functions. The second adhesive layer 13 is used to adhere the polarizing layer 12 to the protective layer 14, the third adhesive layer 16 is used to adhere the compensation film layer 15 to the polarizing layer 12, the protective layer 14 has the function of blocking water vapor, and is used for supporting the entire polarizer at the same time, the compensation film layer 15 is used for compensating for the light leakage in large viewing-angle and color shift, at the same time has the functions of blocking water vapor and supporting the polarizer.

In this embodiment, the material of the first adhesive layer 11 is PSA (Pressure Sensitive Adhesive), the material of the polarizing layer 12 is PVA, the material of the protective layer 14 is Triacetyl Cellulose (TAC), the material of the compensation film layer 15 is TAC or cycloolefin polymer (COP).

In this embodiment, the second adhesive layer 13 and the third adhesive layer 16 are made of UV adhesive. Since the UV adhesive is a material containing no hydrophilic organic solvent, it can reduce the stress caused by the shrinkage of the molecular chain due to the absorption of water in the polarizing layer 12, thereby reducing the bending of the display module.

In this embodiment, it is also possible to reduce the stress of the entire polarizer by reducing the thickness of the polarizing layer 12, wherein, the thickness of the polarizing layer 12 is 10 to 20 μm. By using a thin-type PVA of the polarizing layer 12, the thickness of the entire polarizer can be effectively reduced, thereby reducing the stress generated by the thermal expansion of the polarizing layer 12 and reducing the degree of bending of the display module.

Similarly, in this embodiment, the stress of the entire polarizer can also be reduced by reducing the thickness of the compensation film layer 15, wherein the thickness of the compensation film layer 15 is 20-40 μm. By using a thin-type material of the compensation film layer 15 can effectively reduce the thickness of the entire polarizer, so as to reduce the stress of the entire polarizer and reduce the degree of bending of the display module.

Similarly, in this embodiment, the stress of the entire polarizer can also be reduced by reducing the thickness of the protective layer 14, wherein the thickness of the protective layer 14 is 20-40 μm. By using a thin-type TAC of the protective layer 14, the thickness of the entire polarizer can be effectively reduced, so as to reduce the stress of the entire polarizer, and reduce the degree of bending of the display module.

Referring to FIG. 9, in this embodiment, the stress of the entire polarizer can also be reduced by changing the viscosity of the first adhesive layer 11. Wherein, the first adhesive layer 11 is a soft PSA, that is the PSA is the soft PSA, the soft PSA here refers to a PSA having a glass transition temperature of −20° C. to −70° C., and by selecting the first adhesive layer 11 as the soft PSA can reduce the stress of the entire polarizer, and reduce the degree of bending of the display module.

Referring to FIG. 10, in addition, in this embodiment, the stress of the entire polarizer can also be reduced by selecting the material of the protective layer 14 as a film with low thermal expansion coefficient. Here, the film with low thermal expansion coefficient refers to a material having a thermal expansion coefficient lower than the thermal expansion coefficient of TAO. Since the material of the protective layer 14 is made of a material with a relatively low thermal expansion coefficient, the stress generated by the protective layer 14 during the heating process is relatively small, so that the stress of the entire polarizer can be reduced.

Of course, in order to better reduce the stress of the entire polarizer, the above several solutions can be arbitrarily combined in any combination, and is similar to that of first embodiment, details are not described herein again.

The polarizer in this embodiment further includes a compensation film layer 15. The compensation layer 15 can compensate for light leakage and color shift at a large viewing angle of the display module, so that the display quality of the display module can be further improved.

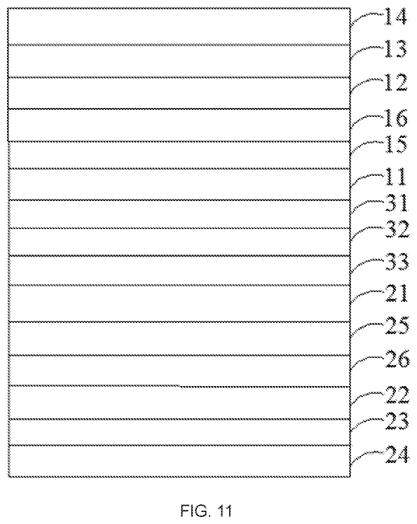

Referring to FIG. 11, the present embodiment further provides a display module including a first polarizer, a second polarizer, and a display layer. The display layer is disposed between the first polarizer and the second polarizer. The optical axes of the first polarizer and the second polarizer are perpendicular to each other, and both the first polarizer and the second polarizer are the above polarizers. The structures of the first polarizer and the second polarizer may be the same or different.

For example, the first polarizer includes a first adhesive layer 11, a compensation film layer 15, a third adhesive layer 16, a polarizing layer 12, a second adhesive layer 13 and a protective layer 14 sequentially disposed in order from the bottom to the top away from the display layer. The second polarizer includes a protective layer 24, a second adhesive layer 23, a polarizing layer 22, a third adhesive layer 26, a compensation film layer 25 and a first adhesive layer 21 sequentially approached to the display layer in order from the bottom to the top. In this case, the structures of the first polarizer and the second polarizer are the same, and the first polarizer and the second polarizer may be any one of the polarizers. Since the second polarizer is in contact with the backlight module, the heat generated in the backlight module is transmitted to the second polarizer. Preferably, in the present embodiment, the protective layer 24 of the second polarizer is thin-type TAO or its material is selected from materials with a lower thermal expansion coefficient.

The display layer in this embodiment includes a OF substrate 31, a liquid crystal layer 32 and a TFT substrate 33. The liquid crystal layer 32 is located between the CF substrate 31 and the TFT substrate 33. The CF substrate 31 is located between the first polarizer and the liquid crystal layer 32. Since the first polarizer and the second polarizer sandwich the display layer therebetween, the degree of bending of the display module can be weakened by reducing the stress of the first polarizer and the second polarizer, so that the phenomenon of light leakage around the display module can be avoided.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A polarizer, comprising: a first adhesive layer, a polarizing layer, a second adhesive layer and a protective layer, the polarizing layer disposed between the first adhesive layer and the second adhesive layer, the second adhesive layer disposed between the polarizing layer and the protective layer, wherein a material of the polarizing layer is high temperature resistance and high humidity resistance polyvinyl alcohol to make a temperature resistance of the polarizer is not less than 60° C. and a humidity resistance is not less than 80%.

2. The polarizer according to claim 1, wherein the humidity resistance is not less than 90%.

3. The polarizer according to claim 1, wherein a thickness of the polarizing layer is 10-20 μm, and/or a thickness of the protective layer is 10-20 μm.

4. The polarizer according to claim 2, wherein a thickness of the polarizing layer is 10-20 μm, and/or a thickness of the protective layer is 10-20 μm.

5. The polarizer according to claim 1, wherein a material of the first adhesive layer is a pressure sensitive adhesive, the pressure sensitive adhesive is a soft pressure sensitive adhesive, and/or a material of the protective layer is selected from a material with thermal expansion coefficient lower than the thermal expansion coefficient of TAO, and/or a material of the second adhesive layer is UV adhesive.

6. The polarizer according to claim 2, wherein a material of the first adhesive layer is a pressure sensitive adhesive, the pressure sensitive adhesive is a soft pressure sensitive adhesive, and/or a material of the protective layer is selected from a material with thermal expansion coefficient lower than the thermal expansion coefficient of TAC, and/or a material of the second adhesive layer is UV adhesive.

7. A polarizer, comprising: a first adhesive layer, a polarizing layer, a second adhesive layer, a third adhesive layer, a compensation film layer and a protective layer, the polarizing layer disposed between the first adhesive layer and the second adhesive layer, the second adhesive layer disposed between the polarizing layer and the protective layer, the third adhesive layer and the compensation film layer disposed between the first adhesive layer and the polarizing layer, the compensation film layer disposed between the first adhesive layer and the third adhesive layer, wherein a material of the polarizing layer is high temperature resistance polyvinyl alcohol to make a temperature resistance of the polarizer is not less than 60° C.

8. The polarizer according to claim 7, wherein the temperature resistance of the polarizer is not less than 80° C.

9. The polarizer according to claim 7, wherein materials of the second adhesive layer and the third adhesive layer are UV adhesive.

10. The polarizer according to claim 9, wherein a thickness of the polarizing layer is 10-20 μm, and/or a thickness of the compensation film layer is 20-40 μm, and/or a thickness of the protective layer is 10-20 μm.

11. The polarizer according to claim 9, wherein a material of the first adhesive layer is a pressure sensitive adhesive, the pressure sensitive adhesive is a soft pressure sensitive adhesive, and/or a material of the protective layer is selected from a material with thermal expansion coefficient lower than the thermal expansion coefficient of TAC.

12. A display module comprising a first polarizer, a second polarizer, and a display layer disposed between the first polarizer and the second polarizer, each of the first polarizer and the second polarizer comprising a first adhesive layer, a polarizing layer, a second adhesive layer and a protective layer, the polarizing layer disposed between the first adhesive layer and the second adhesive layer, the second adhesive layer disposed between the polarizing layer and the protective layer, wherein a material of the polarizing layer is high temperature resistance and high humidity resistance polyvinyl alcohol to make a temperature resistance of the polarizer is not less than 60° C. and a humidity resistance is not less than 80%, or each of the first polarizer and the second polarizer comprising a first adhesive layer, a polarizing layer, a second adhesive layer, a third adhesive layer, a compensation film layer and a protective layer, the polarizing layer disposed between the first adhesive layer and the second adhesive layer, the second adhesive layer disposed between the polarizing layer and the protective layer, the third adhesive layer and the compensation film layer disposed between the first adhesive layer and the polarizing layer, the compensation film layer disposed between the first adhesive layer and the third adhesive layer, wherein a material of the polarizing layer is high temperature resistance polyvinyl alcohol to make a temperature resistance of the polarizer is not less than 60° C.

13. The display module according to claim 12, wherein each of the first polarizer and the second polarizer comprises the first adhesive layer, the polarizing layer, the second adhesive layer and the protective layer, the polarizing layer is disposed between the first adhesive layer and the second adhesive layer, the second adhesive layer is disposed between the polarizing layer and the protective layer, the material of the polarizing layer is high temperature resistance and high humidity resistance polyvinyl alcohol to make the temperature resistance of the polarizer is not less than 60° C., the humidity resistance is not less than 80% and the humidity resistance is not less than 90%.

14. The display module according to claim 12, wherein each of the first polarizer and the second polarizer comprises the first adhesive layer, the polarizing layer, the second adhesive layer and the protective layer, the polarizing layer is disposed between the first adhesive layer and the second adhesive layer, the second adhesive layer is disposed between the polarizing layer and the protective layer, the material of the polarizing layer is high temperature resistance and high humidity resistance polyvinyl alcohol to make the temperature resistance of the polarizer is not less than 60° C., the humidity resistance is not less than 80% and a thickness of the polarizing layer is 10-20 μm, and/or a thickness of the protective layer is 10-20 μm.

15. The display module according to claim 12, wherein each of the first polarizer and the second polarizer comprises the first adhesive layer, the polarizing layer, the second adhesive layer and the protective layer, the polarizing layer is disposed between the first adhesive layer and the second adhesive layer, the second adhesive layer is disposed between the polarizing layer and the protective layer, the material of the polarizing layer is high temperature resistance and high humidity resistance polyvinyl alcohol to make the temperature resistance of the polarizer is not less than 60° C., the humidity resistance is not less than 80% and a material of the first adhesive layer is a pressure sensitive adhesive, the pressure sensitive adhesive is a soft pressure sensitive adhesive, and/or a material of the protective layer is selected from a material with thermal expansion coefficient lower than the thermal expansion coefficient of TAC, and/or a material of the second adhesive layer is UV adhesive.

16. The display module according to claim 12, wherein each of the first polarizer and the second polarizer comprises the first adhesive layer, the polarizing layer, the second adhesive layer, the third adhesive layer, the compensation film layer and the protective layer, the polarizing layer is disposed between the first adhesive layer and the second adhesive layer, the second adhesive layer is disposed between the polarizing layer and the protective layer, the third adhesive layer and the compensation film layer are disposed between the first adhesive layer and the polarizing layer, the compensation film layer are disposed between the first adhesive layer and the third adhesive layer, wherein the material of the polarizing layer is high temperature resistance polyvinyl alcohol to make the temperature resistance of the polarizer is not less than 60° C. and the temperature resistance of the polarizer is not less than 80° C.

17. The display module according to claim 12, wherein each of the first polarizer and the second polarizer comprises the first adhesive layer, the polarizing layer, the second adhesive layer, the third adhesive layer, the compensation film layer and the protective layer, the polarizing layer is disposed between the first adhesive layer and the second adhesive layer, the second adhesive layer is disposed between the polarizing layer and the protective layer, the third adhesive layer and the compensation film layer are disposed between the first adhesive layer and the polarizing layer, the compensation film layer are disposed between the first adhesive layer and the third adhesive layer, wherein the material of the polarizing layer is high temperature resistance polyvinyl alcohol to make the temperature resistance of the polarizer is not less than 60° C. and materials of the second adhesive layer and the third adhesive layer are UV adhesive.

18. The display module according to claim 17, wherein a thickness of the polarizing layer is 10-20 μm, and/or a thickness of the compensation film layer is 20-40 μm, and/or a thickness of the protective layer is 10-20 μm.

19. The display module according to claim 17, wherein a material of the first adhesive layer is a pressure sensitive adhesive, the pressure sensitive adhesive is a soft pressure sensitive adhesive, and/or a material of the protective layer is selected from a material with thermal expansion coefficient lower than the thermal expansion coefficient of TAC.
